(19) United States
(12) Patent Application Publication
(10) Pub. No.: US 2026/0066579 A1
(43) Pub. Date: Mar. 5, 2026

(54) NETWORK MODULE CABLE CLAMP

(71) Applicant: Jyh Eng Technology Co., Ltd., New Taipei City (TW)

(72) Inventors: YEN-LIN LIN, New Taipei City (TW); Meng-Ju Lee, New Taipei City (TW)

(21) Appl. No.: 19/047,088

(22) Filed: Feb. 6, 2025

(30) Foreign Application Priority Data
Aug. 29, 2024 (TW) 113209345

(51) Int. Cl. H01R 13/58; H01R 24/64

(52) U.S. Cl. CPC H01R 13/5812; H01R 13/5829; H01R 24/64; H01R 2201/04

(57) ABSTRACT

A network module cable clamp includes a housing, a first cover body, a second cover body and a crimping cover. The first cover body and the second cover body are pivotally provided on the housing and cover the rear end. The first recess and the second recess of the first cover body and the second cover body form a cable entry hole corresponding to the hollow portion of the rear end. The crimping cover slides relative to the clamping piece of the first cover body. Accordingly, the distance between the crimping piece of the first cover body and the third recess can be adjusted according to the diameter of the cable, to firmly clamp the cable. In addition, the crimping cover is designed to slide relative to the first cover body, which saves space and is easy to operate.

### CROSS REFERENCE TO RELATED APPLICATION

This application claims the benefits of Taiwan application Serial No. 113209345, filed on Aug. 29, 2024, the disclosures of which are incorporated by references herein in its entirety.

### TECHNICAL FIELD

The invention relates to the field of communication transmission technology, especially to a network module cable clamp that can provide the cable clamping fixation, easy operation, simple and quick assembly and disassembly, good structural strength and not easy to be damaged, fewer parts and space-saving.

### DESCRIPTION OF THE RELATED ART

In network equipment rooms, network module jacks are commonly used to connect a variety of cables, including single stranded, multi-stranded, and various core diameters.

In order to reliably locate the cables inside the network module housing, industries in related fields have proposed different solutions, which can generally improve the current problem, but still have different degrees of shortcomings. The following is an explanation of the conventional patents.

For example, the US patent “Communication jack” (U.S. Pat. No. 7,713,081B2) has two cover bodies and a crimping block. When the two cover bodies are at the closed position, the crimping block contacts the cable and pushes against the cable to keep in contact with one of the cover bodies in order to fix the cable. The main disadvantage of the above structure is that the crimping block is equipped with a spring. Due to the spring's elasticity and compressibility, if the cable is deflected, it will drive the spring so that the crimping block will not be able to make exact contact with the cable.

Another example is the US patent “Strain-relief device for a plug-in connection in communications and data systems” (U.S. Pat. No. 7,371,106B2), which has a groove and multiple snap-in structures on each side of the cover body. When two sides of a W-shaped snap-in piece are inserted into the groove, the snap-hook structures formed at the front end of the two sides of the snap-in piece can snap in with one of the snap-in structures to secure the cables. The main disadvantage of the above structure is that it has many complicated parts, high manufacturing costs, and the clamping strength of the W-shaped snap fasteners will be gradually weakened after long-term use, thus affecting the snap fasteners.

Another example is the US patent “Receptacle connector with cable-clamped structure” (U.S. Pat. No. 11,616,321B2) which includes a clamping structure by means of two reversible cover bodies. When the two cover bodies are turned to the closed position, the cable can be secured by clamping it between the two cover bodies. The main disadvantage of the above structure is that since the cover body needs to be turned over to hold the cables, space has to be left on the outside of the jack connector for the two cover bodies to be turned over, which results in the overall length of the jack connector being longer.

Another example is the US patent “Wire containment cap with integral strain relief clip” (U.S. Pat. No. 7,476,120B2), in which the wire containment cap has two opposing guide slots and two rows of locking teeth. The generally eight-shaped chuck is inserted into the guide slots, and the opposing sides of the chuck engage the locks on the locking teeth to secure the cable. The main disadvantage of the above structure is that the chuck structure is fragile and the engagement strength between the chuck and the locking teeth is low. Not only is it difficult to adjust, the chuck is also easy to break during adjustment. In addition, when the cable deflects, the chuck may easily fall off.

Another example is the Chinese patent “Cable fixing device of network module” (Patent No. CN102801042B), in which the left outer housing and the right outer housing are provided with fixing bars, the positioning clamp is equipped with a rack, and the cable movable clamping block with half circle is disposed in the positioning clamp. The cable movable clamping block is synchronously driven to move by moving the positioning clamp, so as to adjust the position required for the fixing bars to fit into the racks, thereby fixing the cable. If the opening head at the top of the positioning clamp is turned upwards, the rack can be separated from the fixing bar to facilitate adjustment. The main disadvantage of the above structure is that the cable movable clamping block is a passive component. The cable movable clamping block must be assembled behind the positioning clamp and driven by the positioning clamp to move against the other half circle of the cable holder. When there is an error in the dimensional fit between the cable movable clamping block and the positioning clamp, the positioning clamp cannot reliably drive the cable movable clamping block to move synchronously. In addition, the interaction between the opening head, the rack and the fixing bars is complicated. If the tooth depth of the rack and fixing bars is too deep, it will be difficult to separate the rack and fixing bars from the opening head. Otherwise, if the tooth depth of the rack and fixing bars is too shallow, they will easily separate from each other. Especially when the cable deflects, it is easy to cause the cable movable clamping block and the positioning clamp to fall off. Furthermore, the force applied to the opening head must be uniform, otherwise it will be difficult to separate the two tooth rows from the fixing bars at the same time. If only one of the tooth rows is separated from the fixing bars, not only will it be impossible to move the cable movable clamping block and positioning clamps, but it can even cause damage to the tooth rows and fixing bars.

Based on the foregoing, how to develop a “network module cable clamp” that can really provide cable clamping fixation, easy operation, simple and fast assembly and disassembly, good structural strength and not easy to be damaged, and fewer parts and space-saving is an urgent issue for the related technical field.

### SUMMARY OF THE UTILIY MODEL

In one embodiment, a network module cable clamp proposed by the present invention includes:
a housing, parallel to an X-axis and having an opposite front end and a rear end, wherein the front end is provided with a jack adapted to a network plug, and the X-axis is perpendicular to a Y-axis and a Z-axis;
a first cover body, having an opposite first inner wall and a first outer wall, wherein the first cover body comprises:
a first recess, provided on one side between the first inner wall and the first outer wall;
a clamping piece, provided on the first outer wall, parallel to the X-axis and protruding from the first outer wall;
a plurality of protrusions, provided on the first outer wall, parallel to the X-axis and protruding from the first outer wall;
wherein the first cover body is pivotally connected to one side of the housing and rotates relative to the rear end between an open position and a closed position, when the first cover body is at the closed position, the first inner wall faces toward the rear end, and the first cover body covers a portion of the rear end;
a second cover body, comprising:
two second cantilevers, wherein length extension directions of the second cantilevers are parallel to the Y-axis and arranged parallel to each other, and each of the second cantilevers has an opposite second inner wall and a second outer wall;
a second recess, provided between the two second cantilevers;
two engaging grooves, wherein each of the second cantilevers is provided with one of the engaging grooves;
at least two engaging teeth, wherein each of the second cantilevers is provided with at least one of the engaging teeth;
two slide rails, wherein the second outer wall of each of the second cantilevers is provided with one slide rail, and a length extension direction of each of the slide rails is parallel to the Y-axis;
a slot, provided on one side of the second recess;
wherein the second cover body is pivoted on another side of the housing relative to the first cover body and rotates relative to the rear end between an open position and a closed position, when the second cover body is at the closed position, the second inner wall faces toward the rear end, and the second cover body covers another portion of the rear end, when the first cover body and the second cover body are both at the closed position, the first recess and the second recess face toward each other and form a cable entry hole, a cable passes through the cable entry hole, and the engaging groove and the corresponding protrusion engage with each other; and
a crimping cover, comprising:
two third cantilevers, wherein length extension directions of the third cantilevers are parallel to the Y-axis and are arranged parallel to each other, and each of the third cantilevers has an opposite third inner wall and a third outer wall;
a third recess, provided between the two third cantilevers;
two tooth rows, wherein each of the third cantilevers is provided with one of the tooth rows respectively, and a length extension direction of each of the tooth rows is parallel to the Y-axis;
two slide grooves, each of the third cantilevers is provided with one of the slide grooves respectively, and a length extension direction of each of the slide grooves is parallel to the Y-axis;
a hook, provided on one side of the third recess;
wherein the crimping cover is parallel to the Y-axis and slides from an outer side of the second cover body toward the clamping piece of the first cover body, each of the engaging teeth is embedded with the corresponding tooth row, each of the slide rails is embedded with the corresponding slide groove, the hook is correspondingly engaged with the slot, a position of the third recess is parallel to the X-axis corresponding to the second recess and parallel to the Y-axis corresponding to the clamping piece, and the cable is located between the third recess and the clamping piece;
wherein the third recess abuts against or separated from the clamping piece to clamp the cable between the third recess and the clamping piece; wherein when the two third cantilevers are pressed toward each other, each of the tooth row is separated from the corresponding engaging tooth.

In a preferred embodiment, a plurality of contact pins are provided inside the jack of the housing, and the rear end of the housing is provided with a plurality of piercing terminal slots, and a piercing terminal is provided inside each of the piercing terminal slots.

In a preferred embodiment, it further includes a cover plate having a hollow portion, wherein the hollow portion is parallel to the X-axis and penetrates the cover plate, a plurality of crimping holders are provided on a surface of the cover plate, the cover plate is arranged on the rear end, the plurality of crimping holders face toward the plurality of piercing terminal slots, each of the crimping holders corresponds to one of the piercing terminal slots, the cable passes through the hollow portion to enter the housing, each core wire of the cable is threaded through each of the piercing terminal slots correspondingly, each of the crimping holders extends into each of the corresponding piercing terminal slots and pushes each of the core wires to be embedded into each of the piercing terminals correspondingly.

In a preferred embodiment, the second outer wall of each of the second cantilevers is provided with at least one limiting block, the third inner wall of each of the third cantilevers is provided with a limiting groove respectively, a length extension direction of each of the limiting grooves is parallel to the Y-axis, the crimping cover is parallel to the Y-axis and slides from an outer side of the second cover body toward the clamping piece of the first cover body, each of the limiting blocks is embedded into the corresponding limiting groove to restrict movement of the third cantilever parallel to the Z-axis.

In a preferred embodiment, each of the limiting blocks is parallel to the Z-axis and has a thickness, each of the limiting grooves is parallel to the Z-axis and has a width, and the width is greater than the thickness.

In a preferred embodiment, the second outer wall of each of the second cantilevers is provided with a stepped stopper, and the third inner wall of each third cantilever is provided with a convex portion, in the process of sliding the crimping cover parallel to the Y-axis relative to the first cover body, when the convex portion contacts the stopper, the crimping cover is restricted for continuing to move parallel to the Y-axis.

In a preferred embodiment, the first outer wall is provided with two protrusions, and the two protrusions are symmetrically arranged on opposite sides of the clamping piece parallel to the Z-axis.

In a preferred embodiment, each of the engaging grooves is parallel to the X-axis and penetrates the second cantilever.

In a preferred embodiment, the first recess and the second recess are in the shape of a circular concave arc, and the cable entry hole formed by the first recess and the second recess is in the shape of a circular shape.

In a preferred embodiment, the first recess, the second recess, and the third recess have the same curvature.

In a preferred embodiment, the hollow portion of the cover plate is circular.

In a preferred embodiment, the third recess is in the shape of a circular concave arc, the clamping piece is in the shape of a circular arc, and a curvature of the third recess is the same as a curvature of the clamping piece.

In a preferred embodiment, each of the engaging teeth is parallel to the X-axis and has a length, each of the tooth rows is parallel to the Y-axis and has a plurality of protruding teeth, and each of the protruding teeth is parallel to the X-axis and has another length.

In a preferred embodiment, a surface of the third recess is provided with a plurality of saw teeth, and the third recess has a surface with the saw teeth facing toward the clamping piece of the first cover body.

In a preferred embodiment, the first inner wall of the first cover body is connected to a first connecting portion, and the first connecting portion has two first shafts, the two first shafts are concentrically located at a distance parallel to the Z-axis, a first pivot hole is provided on an opposite top surface and a bottom surface of the housing respectively, and each of the first shafts is embedded within the first pivot hole.

In a preferred embodiment, the two second cantilevers of the second cover body are connected to a second connecting portion, and the second connecting portion has two second shafts, the two second shafts are concentrically located at a distance parallel to the Z-axis, a second pivot hole is provided on an opposite top surface and a bottom surface of the housing respectively, and each of the second shafts is embedded within the second pivot hole.

In a preferred embodiment, at least one circuit board is provided inside the housing, each of the circuit boards has a printed circuit, the plurality of contact pins and the piercing terminals are respectively provided on opposite surfaces of the circuit board and coupled to the printed circuit, each of the contact pins is electrically connected to one of the piercing terminals, the contact pins extend from the circuit board to the jack, and the piercing terminals extend from the circuit board to the piercing terminal slots.

### BRIEF DESCRIPTION OF THE DRAWINGS

FIG. 1 is a schematic diagram of the combinational structure of the front view and the left view of this creation.

FIG. 2 is a schematic diagram of the combinational structure of the rear view and the left view according to the embodiment of FIG. 1.

FIG. 3 is a schematic diagram of the decomposed structure of the front view and the left view according to the embodiment of FIG. 1.

FIG. 4 is a schematic diagram of the decomposed structure of the rear view and the left view according to the embodiment of FIG. 1.

FIG. 5 is a schematic three-dimensional structural diagram of the first cover body assembled according to the embodiment of FIG. 1.

FIGS. 6 and 7 are schematic structural diagrams of the first cover body from different viewing angles according to the embodiment in FIG. 1.

FIG. 8 is a schematic structural diagram of the second cover body assembled according to the embodiment of FIG. 1.

FIGS. 9 and 10 are schematic structural diagrams of the second cover body from different viewing angles according to the embodiment in FIG. 1.

FIG. 11 is a schematic structural diagram of the crimping cover assembled according to the embodiment of FIG. 1.

FIGS. 12 and 13 are schematic structural diagrams of the crimping cover associated with the second cover body from different viewing angles according to the embodiment in FIG. 1.

FIGS. 14 and 15 are schematic structural diagrams of the front view of the crimping cover associated with the second cover body according to the embodiment in FIG. 1.

### DETAILED DESCRIPTION

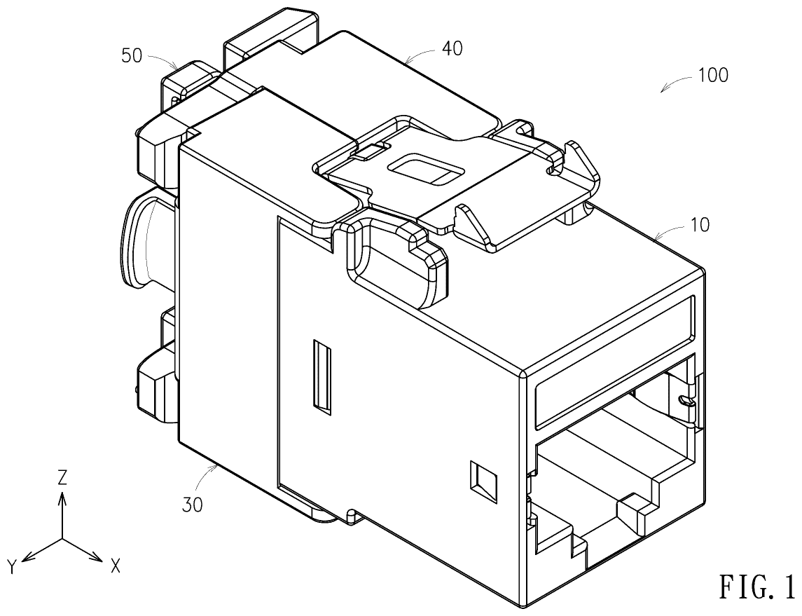

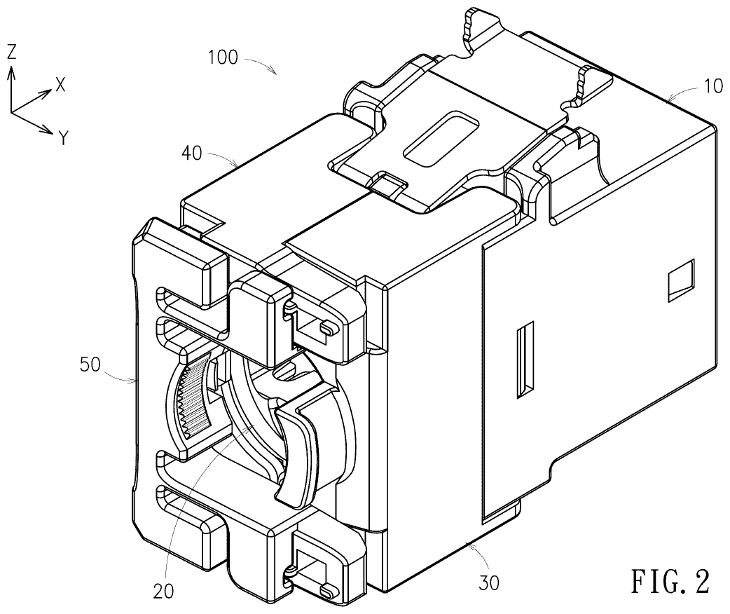

Please refer to the embodiments illustrated in FIGS. 1 to 4. The network module cable clamp 100 provided by the present invention includes a housing 10, a cover plate 20, a first cover body 30, a second cover body 40 and a crimping cover 50.

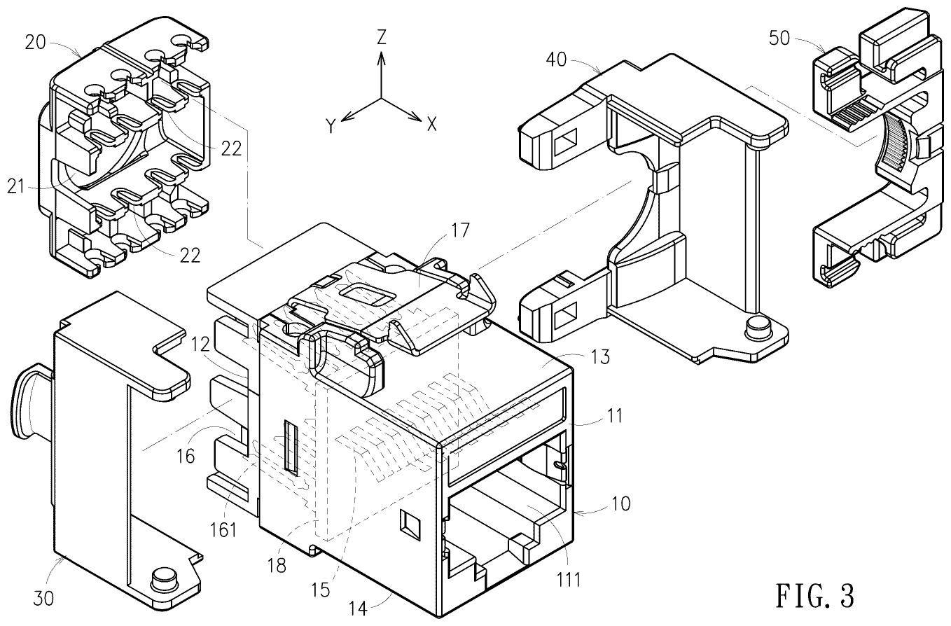

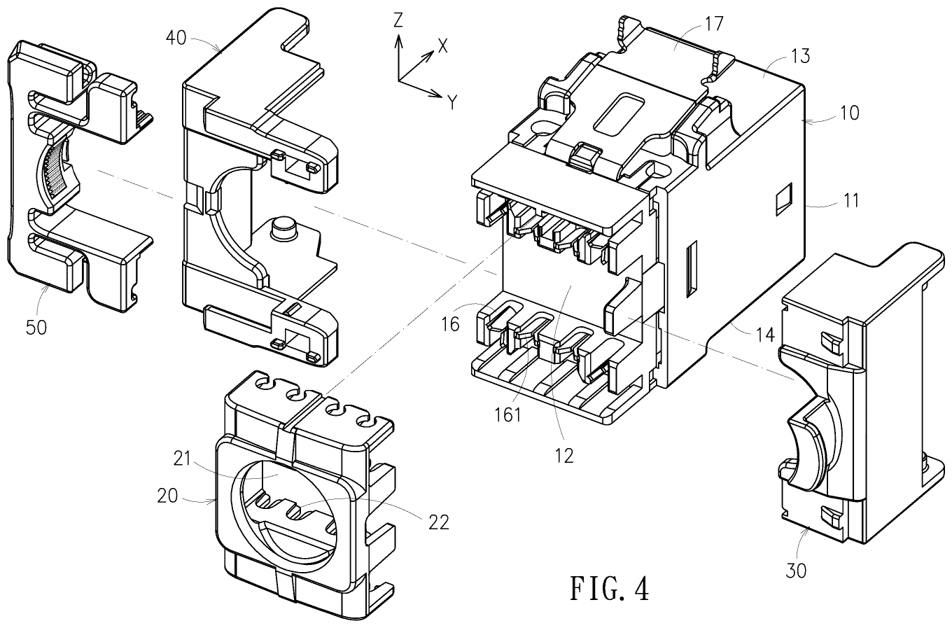

Please refer to FIG. 3 and FIG. 4. The housing 10 is parallel to the X-axis and have an opposite front end 11 and a rear end 12. The front end 11 is provided with a jack 111 adapted to a network plug, and a plurality of contact pins 15 are provided inside the jack 111. A plurality of piercing terminal slots 16 are provided at the rear end 12, and a piercing terminal 161 is provided inside each piercing terminal slot 16.

The X-axis is perpendicular to a Y-axis and a Z-axis. The X-axis and the Y-axis form the XY plane, the X-axis and the Z-axis form the XZ plane, and the Y-axis and the Z-axis form the YZ plane.

The housing 10 is parallel to the Z-axis and have a top surface 13 and a bottom surface 14. The top surface 13 and the bottom surface 14 are both parallel to the XY plane formed by the X-axis and the Y-axis. The top surface 13 is provided with a spring piece 17.

At least one circuit board 18 (as shown in FIG. 3) is disposed inside the housing 10, and each circuit board 18 has a printed circuit. The contact pins 15 and the piercing terminals 161 are respectively disposed on opposite surfaces of the circuit board 18 and coupled with the circuit board 18. Each contact pin 15 is electrically connected to a piercing terminal 161. The contact pins 15 extend from the circuit board 18 to the jack 111. The piercing terminals 161 extend from the circuit board 18 to the piercing terminal slots 16.

Please refer to FIG. 3 and FIG. 4. The cover plate 20 has a hollow portion 21, and the hollow portion 21 penetrates the cover plate 20 parallel to the X-axis. A plurality of wire crimping holders 22 are provided on one surface of the cover plate 20. The cover plate is disposed at the rear end 12 of the housing 10. The crimping holders 22 face toward the piercing terminal slots 16, and each crimping holder 22 corresponds to a piercing terminal slot 16 respectively. In this embodiment, the hollow portion 21 of the cover plate 20 is circular, but is not limited thereto.

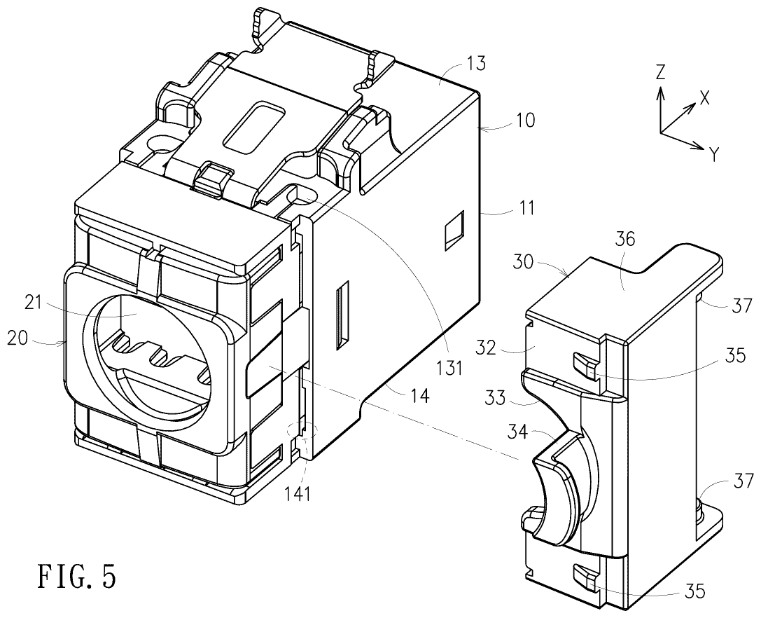

In assembling the cable (not shown in the figure), after the cable passes through the hollow portion 21, each core wire of the cable is threaded through each of the piercing terminal slots 16 correspondingly. Each crimping holder 22 extends into each of the corresponding piercing terminal slots 16 and pushes each of the core wires to be embedded into each of the piercing terminals 161 correspondingly. The state of the cover plate 20 assembled in the housing 10 is illustrated in FIG. 5.

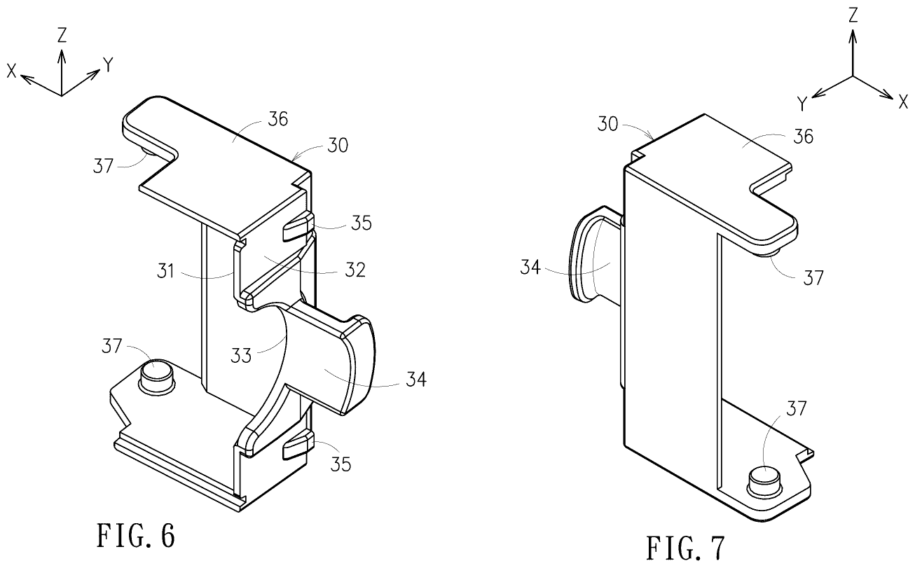

Referring to FIGS. 5 to 7. The first cover body 30 has an opposite first inner wall 31 and a first outer wall 32. The first cover body 30 includes a first recess 33, a clamping piece 34 and a plurality of protrusions 35.

The first recess 33 is disposed on one side between the first inner wall 31 and the first outer wall 32.

The clamping piece 34 is disposed on the first outer wall 32 and protrudes from the first outer wall 32 parallel to the X-axis.

The two protrusions 35 are symmetrically arranged on opposite sides of the clamping piece 34 parallel to the Z-axis and protrude from the first outer wall 32 parallel to the X-axis.

The first inner wall 31 of the first cover body 30 is connected to a first connecting portion 36. The first connecting portion 36 is provided with two first shafts 37. The two first shafts 37 are concentrically located at a distance parallel to the Z-axis. A first pivot hole 131, 141 is provided on the top surface 13 and the bottom surface 14 of the housing 10 respectively. Each first shaft 37 is embedded within a first pivot hole 131, 141.

It is important to note that the first connecting portion 36 is not limited in shape to any geometric structure that can be connected to the first inner wall 31 and can provide two first shafts 37.

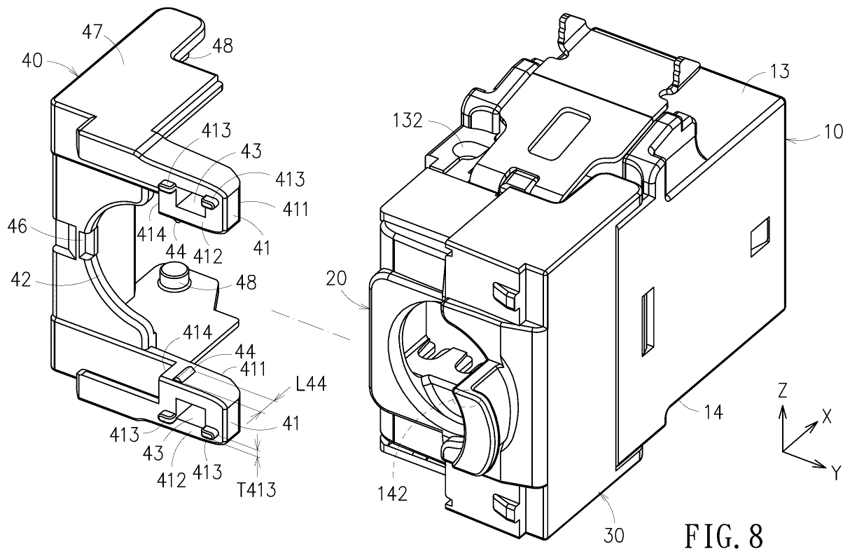

The first cover body 30 is pivotally connected to one side of the housing 10 and can rotate relative to the cover plate 20 of the rear end 12 of the housing 10 between an open position and a closed position. The first cover body 30 is in the closed position. As shown in FIG. 8, the first inner wall 31 faces toward the cover plate 20 of the rear end 12 of the housing 10, and the first cover body 30 covers a portion of the cover plate 20 of the rear end 12 of the housing 10.

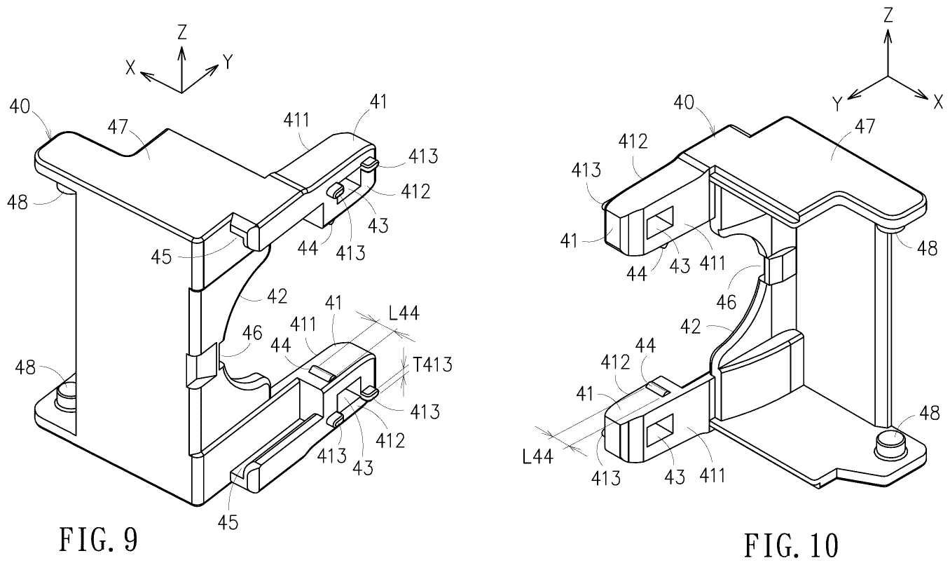

Please refer to FIGS. 8 to 10. The second cover body 40 includes two second cantilevers 41, a second recess 42, two engaging grooves 43, two engaging teeth 44, two slide rails 45 and a slot 46.

The length extension direction of the second cantilever 41 is parallel to the Y-axis and parallel to each other. Each second cantilever 41 has an opposite second inner wall 411 and a second outer wall 412.

The second recess 42 is provided between the two second cantilevers 41.

Each second cantilever 41 is provided with an engaging groove 43. Each engaging groove 43 is parallel to the X-axis and penetrates the second cantilever 41.

Each second cantilever 41 is provided with an engaging tooth 44. Each engaging tooth 44 is parallel to the X-axis and has a length L44.

The second outer wall 412 of each second cantilever 41 is provided with a slide rail 45, and the length extension direction of each slide rail 45 is parallel to the Y-axis.

The slot 46 is disposed on one side of the second recess 42.

Two second cantilevers 41 of the second cover body 40 are connected to a second connecting portion 47. The second connecting portion 47 is provided with two second shafts 48. The two second shafts 48 are concentrically located at a distance parallel to the Z-axis. A second pivot hole 132 is provided on the top surface 13 and the bottom surface 14 of the housing 10 respectively. Each second shaft 48 is embedded within a second pivot hole 132.

It is important to note that the second connecting portion 47 is not limited in shape to any geometric structure that can be connected to the second cantilever 41 and can provide two second shafts 48.

The second outer wall 412 of each second cantilever 41 is provided with two limiting blocks 413, and the two limiting blocks 413 are arranged at a distance parallel to the Y-axis. Each limiting block 413 is parallel to the Z-axis and has a thickness T413.

The second outer wall 412 of each second cantilever 41 is provided with a stepped stopper 414.

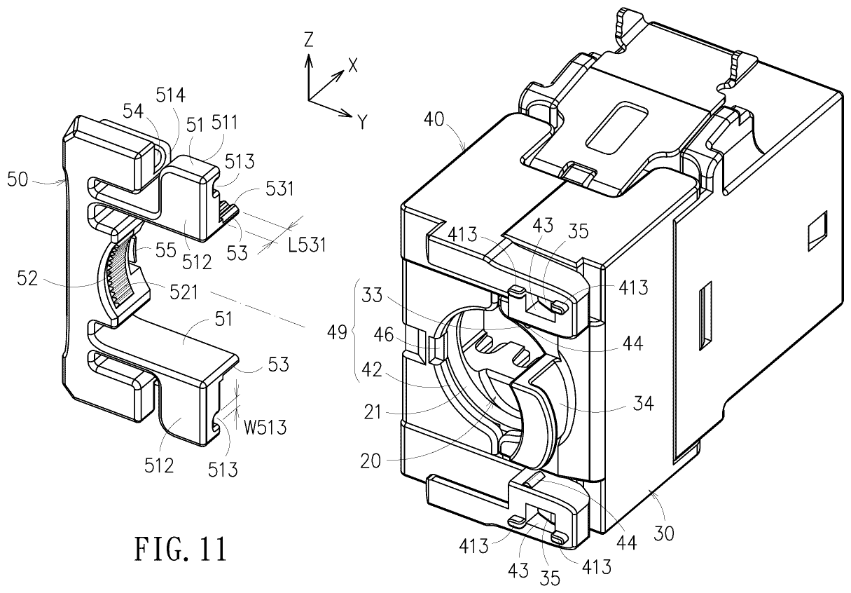

The second cover body 40 is pivoted on another side of the housing 10 relative to the first cover body 30, and it can rotate relative to the cover plate 20 of the rear end 12 of the housing 10 between an open position and a closed position. When the second cover body 40 is at the closed position, as illustrated in FIG. 11, the second inner wall 411 faces toward the cover body 20 of the rear end 12 of the housing 10, and the second cover body 40 covers another portion of the cover plate 20 of the rear end 12 of the housing 10.

As illustrated in FIGS. 8 and 11, when the first cover body 30 and the second cover body 40 are both at the closed position, the first recess 33 and the second recess 42 face toward each other and form a cable entry hole 49. The cable (not shown in the figure) is inserted into the cable entry hole 49. The position of the cable entry hole 49 is parallel to the X-axis and corresponds to the hollow portion 21 of the cover plate 20, and the engaging groove 43 and the corresponding protrusion 35 engage with each other.

In the illustrated embodiment, the first recess 33 and the second recess 42 are in the shape of a circular concave arc, and the cable entry hole 49 formed by the first recess 33 and the second recess 42 is in the shape of a circle.

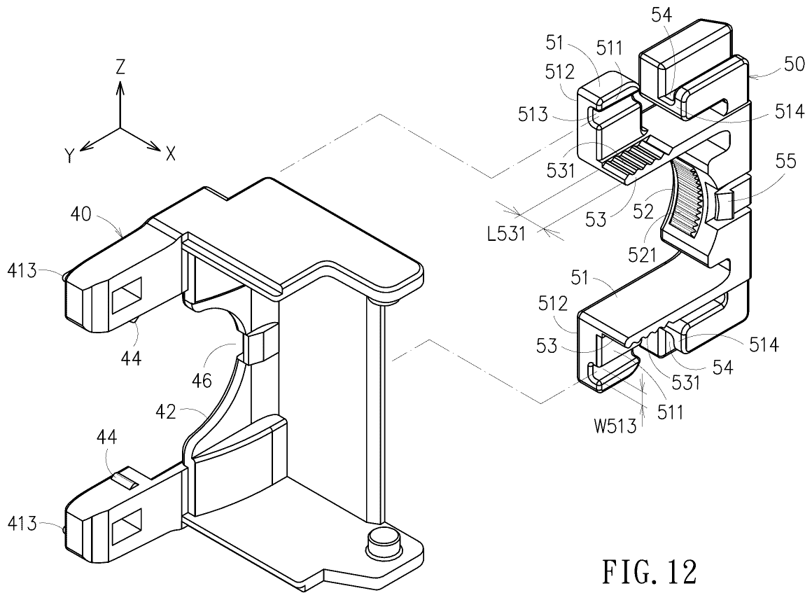

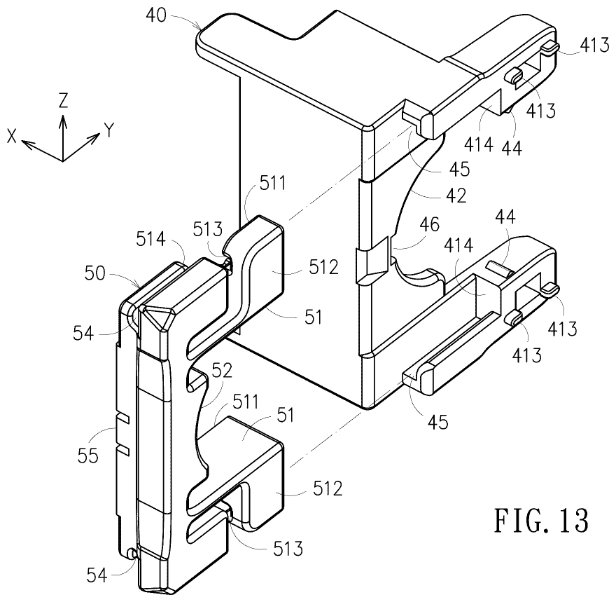

Please refer to FIGS. 11 to 13. The crimping cover 50 includes two third cantilevers 51, a third recess 52, two tooth rows 53, two slide grooves 54 and a hook 55.

The length extension direction of the third cantilevers 51 is parallel to the Y-axis and parallel to each other. Each third cantilever 51 has an opposite third inner wall 511 and a third outer wall 512.

The third recess 52 is disposed between the two third cantilevers 51. A plurality of saw teeth 521 are provided on the surface of the third recess 52, and the third recess 52 has a surface with the saw teeth 521 facing toward the clamping piece 34 of the first cover body 30.

Each third cantilever 51 is respectively provided with a tooth row 53, and the length extending direction of each tooth row 53 is parallel to the Y-axis. Each tooth row 53 is parallel to the Y-axis and has a plurality of protruding teeth 531, and each protruding tooth 531 is parallel to the X-axis and has another length L531.

Each third cantilever 51 is respectively provided with a slide groove 54, and the length extending direction of each slide groove 54 is parallel to the Y-axis.

The hook 55 is provided on one side of the third recess 52.

The third inner wall 511 of each third cantilever 51 is respectively provided with a limiting groove 513. The length extension direction of each limiting groove 513 is parallel to the Y-axis. Each limiting groove 513 is parallel to the Z-axis and has a width W513, and the width W513 is greater than the thickness T413 of the limiting block 413.

The third inner wall 511 of each third cantilever 51 is provided with a convex portion 514.

Please refer to FIGS. 11 to 14. The crimping cover 50 is parallel to the Y-axis and slides from the outside of the second cover body 40 toward the clamping piece 34 of the first cover body 30. Each limiting block 413 is inserted into the corresponding limiting groove 513. Each engaging tooth 44 is embedded with the corresponding tooth row 53. Each slide rail 45 is embedded with the corresponding slide groove 54. The hook 55 is engaged with the engaging groove 46 correspondingly, and the position of the third recess 52 is parallel to the X-axis corresponding to the second recess 42 and parallel to the Y-axis corresponding to the clamping piece 34. The cable 60 is located between the third recess 52 and the clamping piece 34.

By embedding each limiting block 413 into the corresponding limiting groove 513, the movement of the third cantilever 51 is restricted to be parallel with the Z-axis.

The third recess 52 is in the shape of a circular arc, and the clamping piece 34 is in the shape of an arc. The curvature of the third recess 52 may be identical to the curvature of the clamping piece 34.

Furthermore, the curvatures of the first recess 33, the second recess 42, the third recess 52, the clamping piece 34 and the hollow portion 21 of the cover plate 20 may be the same, but are not limited thereto.

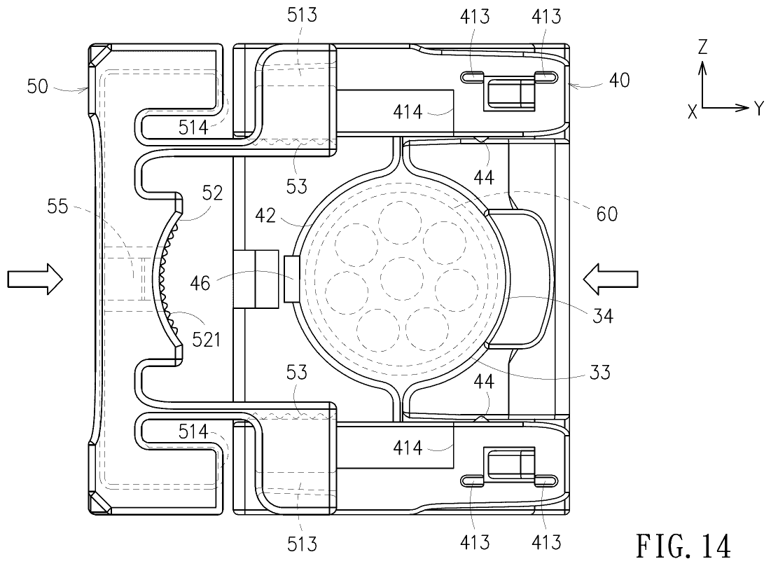

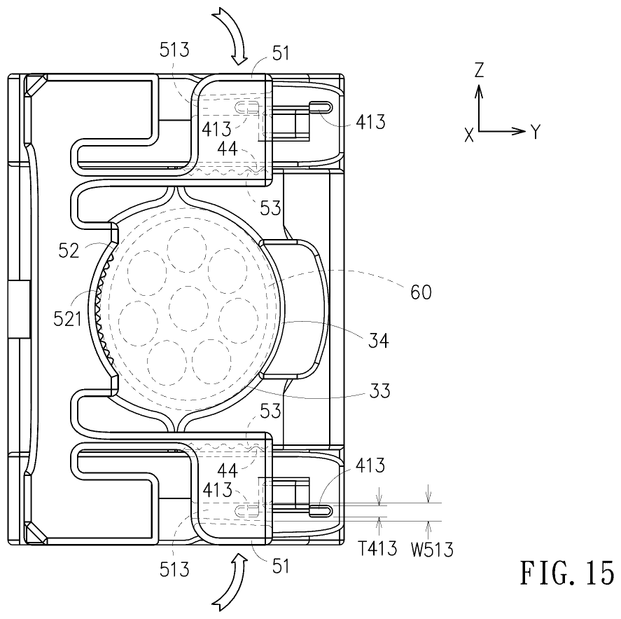

Please refer to FIGS. 14 and 15, the crimping cover 50 is moved parallel to the Y-axis. Each limiting block 413 is inserted into the corresponding limiting groove 513. The position of the engaging teeth 44 engaged with the tooth row 53 can be adjusted, so that the third recess 52 abuts against or separates from the clamping piece 34 to clamp the cable 60 between the clamping piece 34 and the saw teeth 521 of the third recess 52.

Additionally, in the process of sliding the crimping cover 50 parallel to the Y-axis from the outside of the second cover body 40 toward the clamping piece 34 of the first cover body 30, when the convex portion 514 contacts the stopper 414, the crimping cover 50 can be restricted for continuing to move parallel to the Y-axis.

Please refer to FIG. 15. Since the width W513 of the limiting groove 513 is greater than the thickness T413 of the limiting block 413, the third cantilever 51 can have a movable space in the direction of the Z-axis. When the two third cantilevers 51 are pressed toward each other, each tooth row 53 can be separated from its corresponding engaging teeth 44, and the crimping cover 50 can be removed accordingly.

Based on the foregoing, by utilizing the network module cable clamp provided by this invention, the first recess and the second recess of the first cover body and the second cover body form a cable entry hole corresponding to the hollow portion of the cover plate at the rear end of the housing. The crimping cover slides relative to the clamping piece of the first cover body, so as to adjust the gap between the third recess of the crimping cover and the clamping piece of the first cover body according to the diameter of the cable. It can actually provide the fixation of cable clamping, easy operation, simple and quick assembly and disassembly, good structural strength and not easy to be damaged, fewer parts and small overall size. In addition, the design of the crimping cover sliding relative to the first cover body can save space and is easy to operate, making the invention both practical and functional.

Although the disclosure has been disclosed in the form of embodiments, it is not intended to limit the present disclosure. Anyone with general knowledge in the field of technology may make some changes and modifications without departing from the spirit and scope of the present disclosure, and therefore the scope of protection of the disclosure shall be subject to the scope of the patent application attached hereto.

What is claimed is:

1. A network module cable clamp, comprising:
a housing, parallel to an X-axis and having an opposite front end and a rear end, wherein the front end is provided with a jack adapted to a network plug, and the X-axis is perpendicular to a Y-axis and a Z-axis;
a first cover body, having an opposite first inner wall and a first outer wall, wherein the first cover body comprises:
a first recess, provided on one side between the first inner wall and the first outer wall;
a clamping piece, provided on the first outer wall, parallel to the X-axis and protruding from the first outer wall;
a plurality of protrusions, provided on the first outer wall, parallel to the X-axis and protruding from the first outer wall;
wherein the first cover body is pivotally connected to one side of the housing and rotates relative to the rear end between an open position and a closed position, when the first cover body is at the closed position, the first inner wall faces toward the rear end, and the first cover body covers a portion of the rear end;
a second cover body, comprising:
two second cantilevers, wherein length extension directions of the second cantilevers are parallel to the Y-axis and arranged parallel to each other, and each of the second cantilevers has an opposite second inner wall and a second outer wall;
a second recess, provided between the two second cantilevers;
two engaging grooves, wherein each of the second cantilevers is provided with one of the engaging grooves;
at least two engaging teeth, wherein each of the second cantilevers is provided with at least one of the engaging teeth;
two slide rails, wherein the second outer wall of each of the second cantilevers is provided with one of the slide rails, and a length extension direction of each of the slide rails is parallel to the Y-axis;
a slot, provided on one side of the second recess;
wherein the second cover body is pivoted on another side of the housing relative to the first cover body and rotates relative to the rear end between an open position and a closed position, when the second cover body is at the closed position, the second inner wall faces toward the rear end, and the second cover body covers another portion of the rear end, when the first cover body and the second cover body are both at the closed position, the first recess and the second recess face toward each other and form a cable entry hole, a cable passes through the cable entry hole, and the engaging groove and the corresponding protrusion engage with each other; and
a crimping cover, comprising:
two third cantilevers, wherein length extension directions of the third cantilevers are parallel to the Y-axis and are arranged parallel to each other, and each of the third cantilevers has an opposite third inner wall and a third outer wall;
a third recess, provided between the two third cantilevers;
two tooth rows, wherein each of the third cantilevers is provided with one of the tooth rows respectively, and a length extension direction of each of the tooth rows is parallel to the Y-axis;
two slide grooves, each of the third cantilevers is provided with one of the slide grooves respectively, and a length extension direction of each of the slide grooves is parallel to the Y-axis;
a hook, provided on one side of the third recess;
wherein the crimping cover is parallel to the Y-axis and slides from an outer side of the second cover body toward the clamping piece of the first cover body, each of the engaging teeth is embedded with the corresponding tooth row, each of the slide rails is embedded with the corresponding slide groove, the hook is correspondingly engaged with the slot, a position of the third recess is parallel to the X-axis corresponding to the second recess and parallel to the Y-axis corresponding to the clamping piece, and the cable is located between the third recess and the clamping piece;
wherein the third recess abuts against or separated from the clamping piece to clamp the cable between the third recess and the clamping piece; wherein when the two third cantilevers are pressed toward each other, each of the tooth row is separated from the corresponding engaging tooth.

2. The network module cable clamp of claim 1, wherein a plurality of contact pins are provided inside the jack of the housing, and the rear end of the housing is provided with a plurality of piercing terminal slots, and a piercing terminal is provided inside each of the piercing terminal slots.

3. The network module cable clamp of claim 2, further comprising a cover plate having a hollow portion, wherein the hollow portion is parallel to the X-axis and penetrates the cover plate, a plurality of crimping holders are provided on a surface of the cover plate, the cover plate is arranged on the rear end, the plurality of crimping holders face toward the plurality of piercing terminal slots, each of the crimping holders corresponds to one of the piercing terminal slots, the cable passes through the hollow portion to enter the housing, each core wire of the cable is threaded through each of the piercing terminal slots correspondingly, each of the crimping holders extends into each of the corresponding piercing terminal slots and pushes each of the core wires to be embedded into each of the piercing terminals correspondingly.

4. The network module cable clamp of claim 1, wherein the second outer wall of each of the second cantilevers is provided with at least one limiting block, the third inner wall of each of the third cantilevers is provided with a limiting groove respectively, a length extension direction of each of the limiting grooves is parallel to the Y-axis, the crimping cover is parallel to the Y-axis and slides from an outer side of the second cover body toward the clamping piece of the first cover body, each of the limiting blocks is embedded into the corresponding limiting groove to restrict movement of the third cantilever parallel to the Z-axis.

5. The network module cable clamp of claim 4, wherein each of the limiting blocks is parallel to the Z-axis and has a thickness, each of the limiting grooves is parallel to the Z-axis and has a width, and the width is greater than the thickness.

6. The network module cable clamp of claim 4, wherein the second outer wall of each of the second cantilevers is provided with two limiting blocks, and the two limiting blocks are arranged at a distance parallel to the Y-axis.

7. The network module cable clamp of claim 1, wherein the second outer wall of each of the second cantilevers is provided with a stepped stopper, and the third inner wall of each third cantilever is provided with a convex portion, in the process of sliding the crimping cover parallel to the Y-axis relative to the first cover body, when the convex portion contacts the stopper, the crimping cover is restricted for continuing to move parallel to the Y-axis.

8. The network module cable clamp of claim 1, wherein the first outer wall is provided with two protrusions, and the two protrusions are symmetrically arranged on opposite sides of the clamping piece parallel to the Z-axis.

9. The network module cable clamp of claim 1, wherein each of the engaging grooves is parallel to the X-axis and penetrates the second cantilever.

10. The network module cable clamp of claim 1, wherein the first recess and the second recess are in the shape of a circular concave arc, and the cable entry hole formed by the first recess and the second recess is in the shape of a circular shape.

11. The network module cable clamp of claim 1, wherein the first recess, the second recess, and the third recess have the same curvature.

12. The network module cable clamp of claim 3, wherein the hollow portion of the cover plate is circular.

13. The network module cable clamp of claim 1, wherein the third recess is in the shape of a circular concave arc, the clamping piece is in the shape of a circular arc, and a curvature of the third recess is the same as a curvature of the clamping piece.

14. The network module cable clamp of claim 1, wherein each of the engaging teeth is parallel to the X-axis and has a length, each of the tooth rows is parallel to the Y-axis and has a plurality of protruding teeth, and each of the protruding teeth is parallel to the X-axis and has another length.

15. The network module cable clamp of claim 1, wherein a surface of the third recess is provided with a plurality of saw teeth, and the third recess has a surface with the saw teeth facing toward the clamping piece of the first cover body.

16. The network module cable clamp of claim 1, wherein the first inner wall of the first cover body is connected to a first connecting portion, and the first connecting portion has two first shafts, the two first shafts are concentrically located at a distance parallel to the Z-axis, a first pivot hole is provided on an opposite top surface and a bottom surface of the housing respectively, and each of the first shafts is embedded within the first pivot hole.

17. The network module cable clamp of claim 1, wherein the two second cantilevers of the second cover body are connected to a second connecting portion, and the second connecting portion has two second shafts, the two second shafts are concentrically located at a distance parallel to the Z-axis, a second pivot hole is provided on an opposite top surface and a bottom surface of the housing respectively, and each of the second shafts is embedded within the second pivot hole.

18. The network module cable clamp of claim 2, wherein at least one circuit board is provided inside the housing, each of the circuit boards has a printed circuit, the plurality of contact pins and the piercing terminals are respectively provided on opposite surfaces of the circuit board and coupled to the printed circuit, each of the contact pins is electrically connected to one of the piercing terminals, the contact pins extend from the circuit board to the jack, and the piercing terminals extend from the circuit board to the piercing terminal slots.
